(19) United States
(12) Patent Application Publication
(10) Pub. No.: US 2014/0274262 A1
(43) Pub. Date: Sep. 18, 2014

(54) Auction Closing Price Guessing Game System

(71) Applicant: Manuel Ongkingco DelaCruz, JR., Mapleton, UT (US)

(72) Inventor: Manuel Ongkingco DelaCruz, JR., Mapleton, UT (US)

(21) Appl. No.: 13/798,046

(22) Filed: Mar. 12, 2013

(51) Int. Cl. A63F 13/00

(52) U.S. Cl. CPC A63F 13/005
USPC 463/16

(57) ABSTRACT

An auction closing price guessing game system is a method for attracting participants to an auction, even if they have no interest in buying the item being auctioned. A system for an auction closing price guessing game includes a processor; memory operably connected to the processor; client bidding and guessing, auction end, and month end programs loaded into the memory and operable by the processor; lists of user data, item listings, bids data, and guesses data loaded into the memory and operable by the processor; and the current time loaded into the memory and operable by the processor.

### FIELD OF THE INVENTION

The present invention relates to games, and more particularly to a system to operate a game directed towards guessing the correct closing price of an online Internet-based auction of an item.

### BACKGROUND OF THE INVENTION

An auction is a process of buying and selling goods or services by offering them up for bid, taking bids, and then selling the item to the highest bidder. Although auctions have been a relatively uncommon way to negotiate the exchange of goods and commodities before the 17 century, auctions have a long history, having been recorded as early as 500 BC.

An online auction is an auction which is held over the Internet. The first Web-based commercial activity regarding online auctions that made significant sales began in May 1995 with the company Onsale. In September 1995, eBay also began trading. Both of these companies were the first of their kind to take advantage of the new technological opportunities. The Web offered new advantages such as the use of automated bids via electronic forms, a search engine to be able to quickly find items, and the ability to allow users to view items by categories. Online auctions come in many different formats, but the most popular are ascending English auctions and descending Dutch auctions.

In English auctions, also known as open ascending price auctions, participants bid openly against one another, with each subsequent bid higher than the previous bid. An auctioneer may announce prices, bidders may call out their bids themselves (or have a proxy call out a bid on their behalf), or bids may be submitted electronically with the highest current bid publicly displayed. In some cases a maximum bid might be left with the auctioneer, who may bid on behalf of the bidder according to the bidder's instructions. The auction ends when no participant is willing to bid further, at which point the highest bidder pays their bid. Sometimes the auctioneer sets a minimum amount by which the next bid must exceed the current highest bid. The most significant distinguishing factor of this auction type is that the current highest bid is always available to potential bidders. The popularity of the English auction as an online transaction method is attributable to its use of a mechanism that people find familiar and intuitive. It also transcends the boundaries of a traditional English auction by eliminating the requirement for bidders to be physically present.

English auctions can take the form of No-reserve auctions or Reserve auctions. A No-reserve auction is an auction in which the item for sale will be sold regardless of price. From the seller's perspective, advertising an auction as having no reserve price can be desirable because it potentially attracts a greater number of bidders because of the possibility of a buyer receiving a bargain. If more bidders attend the auction, a higher price might ultimately be achieved because of heightened competition from bidders.

A Reserve auction is an auction where the item for sale may not be sold if the final bid is not high enough to satisfy the seller; that is, the seller reserves the right to accept or reject the highest bid. In these cases a set “reserve” price known to the auctioneer, but not necessarily to the bidders, is set by the seller, below which the item may not be sold. The reserve price may be fixed or discretionary. In the latter case, the decision to accept a bid is deferred to the auctioneer, who may accept a bid that is marginally below it. A reserve auction is safer for the seller than a no-reserve auction as they are not required to accept a low bid, but this could result in a lower final price if less interest is generated in the sale.

Traditionally, Dutch auctions are the reverse of English auctions whereby the price begins high and is systematically lowered until a buyer accepts the price. However, the term “Dutch auction” has taken on an alternative meaning in the context of online auctions. In the online context, and in the context of the specification, the term “Dutch auction” is used when multiple identical goods are sold simultaneously to an equal number of high bidders.

Online auctions have greatly increased the variety of goods and services that can be bought and sold using auction mechanisms, along with expanding the possibilities for the ways auctions can be conducted and have created new uses for auctions. In the current online Internet environment there are thousands of websites conducting some form of online auctions listing hundreds of millions of items (eBay alone averages in excess of 112 million item listings at any given time).

As a result, while online auctions are exceedingly popular, individual websites, particularly less well-known ones, have the challenge of attracting a sufficient number of buyers and sellers to generate profitable transaction volumes. Furthermore, a critical mass of buyers and sellers is necessary for both buyers and sellers to be satisfied with the variety of items listed on a particular site and the number of bids per listing. Although bidding on items can be entertaining to buyers, buyers are also typically legally obligated to buy the item if they submit the winning bid. As a result, buyers generally limit the number of items they actually bid on and focus their attention on only items they want to buy.

Therefore, a need exists for a new and improved auction closing price guessing game system that awards prizes based on the accuracy of guesses to attract more participants to each auction, regardless of whether or not the participants have any interest in buying the item being auctioned. In this regard, the various embodiments of the present invention substantially fulfill at least some of these needs. In this respect, the auction closing price guessing game system according to the present invention substantially departs from the conventional concepts and designs of the prior art, and in doing so provides an apparatus primarily developed for the purpose of providing participants the opportunity to participate in an auction without being required to submit bids that could result in the purchase of the item being auctioned.

### SUMMARY OF THE INVENTION

The present invention provides an improved auction closing price guessing game system, and overcomes the above-mentioned disadvantages and drawbacks of the prior art. As such, the general purpose of the present invention, which will be described subsequently in greater detail, is to provide an improved auction closing price guessing game system that has all the advantages of the prior art mentioned above.

To attain this, the preferred embodiment of the present invention essentially comprises a method for determining the most accurate guess of the winning bid price for an item at auction that includes obtaining a list of guesses of winning bid prices for an item at auction; obtaining a winning bid price for the item at auction; for each guess, determining if the guess is greater than or equal to the winning bid price; and responsive to determining the guess is greater than or equal to the winning bid price, recording the guess in a list of qualifying guesses. The method may also include for each guess in the list of qualifying guesses, calculating the difference between the guess and the winning bid price; responsive to calculating the difference between the guess and the winning bid price, recording the difference in the list of qualifying guesses; sorting the guesses in the list of qualifying guesses from the lowest difference to the highest difference; and recording the sorted guesses in a list of best guesses. The method may also include awarding a prize to a guess with the lowest difference. The prize may be points, credits, money, or an item. The list of qualifying guesses may be stored in a machine-readable form. The list of guesses may be obtained after the auction begins and before the auction ends. A guess having the highest value may be displayed to participants in the auction during the auction. The auction may be conducted over a network. The method may be operable in an apparatus including a processor and memory. The list of qualifying guesses in machine-readable form may be an XML file, a character-delimited file, or a database. The apparatus may also include a Web server containing a website with a network connection to a client. The auction may be a no reserve open ascending price auction or a reserve open ascending price auction.

According to one embodiment of the present invention, a system for an auction closing price guessing game includes a processor; memory operably connected to the processor; a client bidding and guessing program loaded into the memory and operable by the processor; an auction end program loaded into the memory and operable by the processor; a month end program loaded into the memory and operable by the processor; a list of user data loaded into the memory and operable by the processor; a list of item listings loaded into the memory and operable by the processor; a list of bids data loaded into the memory and operable by the processor; a list of guesses data loaded into the memory and operable by the processor; and current time data loaded into the memory and operable by the processor.

According to one embodiment of the present invention, a computer program product for providing auction closing price guessing game includes a computer readable medium; first program instructions to obtain a list of guesses of winning bid prices for an item at auction; second program instructions to obtain a winning bid price for the item at auction; third program instructions to determine if each guess in the list of guesses is greater than or equal to the winning bid price; fourth program instructions to record the guess in a list of qualifying guesses if the guess is greater than or equal to the winning bid price; fifth program instructions to calculate the difference between each guess in the list of qualifying guesses and the winning bid price; sixth program instructions to record the difference in the list of qualifying guesses; seventh program instructions to sort the guesses in the list of qualifying guesses from the lowest difference to the highest difference; eighth program instructions to record the sorted guesses in a list of best guesses; and ninth program instructions to award a prize to a guess with the lowest difference. The list of guesses and the winning bid price may be obtained from a website. The list of guesses may be obtained while the item is being auctioned, and the winning bid price may be obtained after the item has been auctioned.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is a schematic view of an embodiment of the auction closing price guessing game system constructed in accordance with the principles of the present invention

FIG. 2 is a schematic view of an embodiment of the Web server of the present invention.

FIG. 3 is a flow diagram of an embodiment of the client bidding and guessing program of the present invention.

FIGS. 4A & 4B are a flow diagram of an embodiment of the auction end program of the present invention.

FIG. 5 is a flow diagram of an embodiment of the month then program of the present invention.

FIG. 6 is a schematic view of an embodiment of the user data of the present invention.

FIG. 7 is a schematic view of an embodiment of the item listings of the present invention.

FIG. 8 is a schematic view of an embodiment of the bids data of the present invention.

FIG. 9 is a schematic view of an embodiment of the guesses data of the present invention.

FIG. 10 is a schematic view of an embodiment of the current time data of the present invention.

The same reference numerals refer to the same parts throughout the various figures.

### DESCRIPTION OF THE CURRENT EMBODIMENT

An embodiment of the auction closing price guessing game system of the present invention is shown and generally designated by the reference numeral 10.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc. The medium may be remote to the user, thus allowing the use of the program over a large area computer network, including a global network such as the Internet.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), whether via wireless, wireline or other transmission means.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Referring now to FIG. 1, an embodiment of the auction price guessing game 10 is illustrated. More particularly, the embodiment of the game 10 includes at least one client (represented by Client A 12, Client B 14, Client C 16, and Client D 18) connected by a network 20 (preferably the Internet) to a Web server 22. The users of the clients can act as any combination of sellers, buyers, and auction price guessers with respect to any of the item listings 28 that qualify for guessing, and can assume the roles of seller and guesser or buyer and guesser simultaneously for any given item listing that qualifies for guessing. Game participants will be encouraged to seek out auctions they can submit guesses on, thereby driving up overall traffic levels to the auction website providing the game. Only guesses that are greater than the current high bid are shown to other users, reinforcing the perceived value of items listed on the website, and encouraging further bidding. Participation of the user in the game will deepen the user's commitment to the auction website, increasing loyalty and patronage.

Resources and programs can be stored in database 24, which may be a hard drive or other storage device accessible by the Web server. Examples of resources may include user data 26, item listings 28, bids 30, guesses 32, and the current time 42 stored in machine-readable form, including XML files and/or character-delimited files within the database. Item listings can be for material goods of any kind or services of any kind The clients can use the network to access webpages 34 from a website 36 hosted on the Web server. The Web server may be located anywhere in the world. The webpages may contain content in any language.

FIG. 2 illustrates an embodiment of the Web server 22 of the present invention. More particularly, Web server 22 has a processor 38 and memory 40 operably connected to the processor. A client bidding and guessing program 100, auction end program 200, and month end program 300 are loaded into the memory and provide instructions to the processor. The memory also stores the user data, item listings, bids data, guesses data, and current time when that data is being supplied to the processor from the database 24. The client bidding and guessing program identifies registered users, provides registered users with item listings to bid and guess on, and records registered users' bids and guesses data in the database. The auction end program searches the item listings for auctions that have just ended and records any points earned by guesses in the database. The month end program runs at the end of every month, provides prizes to the users with the most points earned from guessing, and resets the total points awarded for the month field 412 to zero.

FIG. 3 illustrates an embodiment of the client bidding and guessing program 100 of the present invention. More particularly, the client bidding and guessing program 100 begins (102) by determining if the user of a client (12-18) is a registered user (104). This can be accomplished by many methods, including matching a username and password provided by the user of the client to username 400 and password 416 fields in the user data 26 in the database 24. If the user of the client is not a registered user, the program offers the user of the client the opportunity to register (106). If the user of the client wants to register, the program asks the user to provide client data (108) to populate the username 400, password 416, contact information 418, and Federal Firearms License (FFL) status 420 fields in the user data in the database. If the user of the client does not wish to register, then the client bidding and guessing program ends 122.

After the client bidding and guessing program 100 has either established the user of client (12-18) is a registered user or has registered the user, the program provides item listings 28 for the current auctions (110). If the user of the client desires to bid on an item (112), the program obtains the user's bid information (current bid amount 600 and maximum bid amount 602) and records the bid information, the item number 500, and the username 400 in the bids data 30 in the database 24 (114). The program can repeat steps 112 and 114 multiple times if the user of the client desires to bid on multiple items in a single usage session before advancing to step 116.

After the user of the client (12-18) has provided their bid information, or if the user of the client does not want to bid on an item, the program 100 provides item listings 28 for the current auctions that are “qualified for guessing” if at least one item in the item listings qualifies (116). In the current embodiment, an item is “qualified for guessing” if it has all of the following characteristics:
the item must have an auction type 504 of either Non-reserve or Reserve (Dutch auctions or any other auction types do not qualify);
the item must not have a Buy It Now price 508 specified;
the item must be used (new items do not qualify);
the auction will not end for at least one hour (no guesses are accepted within one hour of the auction's end); and
the user has not already submitted a guess for the item (users can only submit one guess per auction, which cannot be changed after submission).

If the user of the client (12-18) desires to guess on an item (118), the program 100 obtains the user's guess information (guess amount 700 and guess time 702) and records the guess information, the item number 500, and the username 400 in the guess data 32 in the database 24 (120). The program can repeat steps 118 and 120 multiple times if the user of the client desires to guess on multiple items in a single usage session before advancing to step 122. In the current embodiment, there is no limit to the number of item auctions to which users can submit a guess. Users can submit as many guesses as there are qualifying item auctions available.

After the user of the client (12-18) has provided their guess information, or if the user of the client does not want to guess on an item, the program 100 ends (122).

FIGS. 4A & 4B illustrate an embodiment of the auction end program 200 of the present invention. More particularly, the auction end program 200 begins (202) by comparing the auction end time 510 field for every item in the item listings data 28 against the current time 42 to determine if an item's auction has just ended (204). Step 202 repeats until an item with a just ended auction is identified. The program then accesses the bids data 30 in the database 24 to identify if there was a winning bid amount for the item (206). In the current embodiment, a winning bid is the highest bid greater than $0 in a No-reserve auction. For there to be a winning bid in a Reserve auction, a bid must meet the previous requirements and also exceed the reserve price. If there was not a winning bid, then the program ends 228.

If there was a winning bid amount for the item, the program 200 checks the guesses data 32 in the database 24 to determine if there were any guesses for the item (208). If there were no guesses, than the program ends (228). If there is at least one guess, the program 200 determines which of the guesses was the auction's first guess (210) by finding the earliest guess time 702 in the guesses data 32 stored in the database 24. After identifying the user who made the auction's first guest, the program records a first guess bonus (50 points in the current embodiment) in the first guess bonus 408 field of the user data 26 stored in the database 24 (212).

The program 200 then checks if any of the guesses qualify as “best guesses” (214) In the current embodiment, a guess qualifies as a “best guess” if it is equal to or greater than the winning bid. Guesses surpassed by the amounts bid during the auction are disqualified for that auction, and are not shown to other users during the auction. If there were not any guesses qualifying as “best guesses,” the program proceeds to step 224.

If there was at least one qualifying “best guess,” then the program 200 continues to evaluate the “best guesses” in step 214 to determine if any qualify for proximity points. A “best guess” qualifies for proximity points if it is within $5 of the winning bid amount.

Subsequently, the program 200 awards placement points (216) by adding points to the placement points 402 field in the user data 26 in the database 24. In the current embodiment, the closest guess to the winning bid amount is awarded 5000 points, the second closest guess to the winning bid amount is awarded 2000 points, and the third closest guess to the winning bid amount is awarded 1000 points.

The program 200 then awards proximity points if any “best guesses” qualified for proximity points (218). If no “best guesses” qualified for proximity points, the program proceeds to step 224. Otherwise, the program adds points to the proximity points 404 field in the user data 26 in the database 24. In the current embodiment, a guess that exactly matches the winning bid is awarded 5000 points, a guess that is higher than the winning bid but within $1 of the winning bid is awarded 500 points, and a guess that is higher than $1 of the winning bid but within $5 of the winning bid is awarded 100 points.

The program 200 then determines if any of the “best guesses” were made more than three days before the auction end time (220) by comparing the guess time 702 in the guesses data 32 stored in the database 24 to the auction end time 510 in the item listings data 28 stored in the database 24. If no “best guesses” were made more than three days before the auction end time, then the program proceeds to step 224.

If any of the “best guesses” were made more than three days before the auction end time, the program 200 awards an early bird multiplier based on how many days in advance of the auction end time the guess was made (222). In the current embodiment, the multiplier is 3 for a guess made five or more days in advance, and the multiplier is 2 for a guess made more than three days in advance and less than five days in advance. The program records the multiplier in the early bird multiplier 406 field of the user data 26 stored in the database 24.

The program 200 then proceeds to award participation bonuses (10 points in the current embodiment) by recording the participation bonus amount in the participation bonuses 410 field of the user data 26 stored in the database 24 (224).

The program 200 then updates the month and lifetime total points awarded (412, 414) fields of the user data 26 stored in the database 24 (226). This is accomplished by taking the existing month total and lifetime total values and adding to them the total of the placement points 402 and the proximity points 404 multiplied by the early bird multiplier 406, the first guess bonus 408, and the participation bonus 410. After the new month total and lifetime total values are recorded in the user data 26 stored in the database 24, the placement points, proximity points, early bird multiplier, first guess bonus, and participation bonus are reset to 0. The auction end program 200 then ends (228).

FIG. 5 illustrates an embodiment of the month end program 300 of the present invention. More particularly, the month end program 300 begins (302) by determining if the month has ended (304) by checking the current time 42. Step 302 repeats until a just ended month is identified. As soon as a month-end is identified, the auction end program 200 is prevented from executing until the month end program has completed steps 306-312. Stoppage of the auction end program 200 prevents points that would be newly earned at the beginning of the new month for auctions ending at the beginning of the new month from being inappropriately deleted. The program then accesses the user data 26 in the database 24 to identify the users with the largest month total 412 field values (306). In the current embodiment, the three users with the highest month total values are identified. Once these users are identified, they are awarded prizes (308). Prizes could include cash, credits that can be used to pay winning bid amounts, and/or items or services. The awarding of prizes may be a function of the program 300 or be performed by the owner of the website operating the game of the current invention.

The program 300 then proceeds to step 310, which consists of resetting the month total 412 field value to 0. The program 300 then ends (312), and the auction end program 200 is permitted to resume execution.

FIG. 6 illustrates an embodiment of the user data 26 of the present invention. More particularly, the user data 26 contains a list of usernames 400, passwords 416, contact information 418, Federal Firearm License (FFL) status 420, and the various categories of guess awards data. Guess awards data may include placement points 402, proximity points 404, and early bird multiplier 406, a first guess bonus 408, a participation bonus 410, a month total 412, and a lifetime total 414.

FIG. 7 illustrates an embodiment of the item listings 28 of the present invention. More particularly, the item listings 28 contains a list of item numbers 500, item names 502, auction types 504, reserve prices 506, buy it now prices 508, auction end times 510, and new or used condition 512. In alternative embodiments, additional fields in the item listings 28 could be provided to contain item descriptions and item images, or item descriptions and item images could be stored elsewhere in the database 24.

FIG. 8 illustrates an embodiment of the bids data 30 of the present invention. More particularly, the bids data 30 contains a list of item numbers 500, usernames 400, current bid amounts 600, and maximum bid amounts 602.

FIG. 9 illustrates an embodiment of the guesses data 32 of the present invention. More particularly, the guesses data 32 contains a list of item numbers 500, usernames 400, guess amounts 700, and guess times 702.

FIG. 10 illustrates an embodiment of the current time data 42 of the present invention. More particularly, the current time data 28 contains the current year 800, month 802, day 104, hours 806, minutes 808, and seconds 810. The current time data can be obtained from the Web server's system time or from an Internet-based timeserver.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

I claim:

1. A method for determining the most accurate guess of the winning bid price for an item at auction comprising:
obtaining a list of guesses of winning bid prices for an item at auction;
obtaining a winning bid price for the item at auction;
for each guess, determining if the guess is greater than or equal to the winning bid price; and
responsive to determining the guess is greater than or equal to the winning bid price, recording the guess in a list of qualifying guesses.

2. The method of claim 1 further comprising:
for each guess in the list of qualifying guesses, calculating the difference between the guess and the winning bid price;
responsive to calculating the difference between the guess and the winning bid price, recording the difference in the list of qualifying guesses;
sorting the guesses in the list of qualifying guesses from the lowest difference to the highest difference; and
recording the sorted guesses in a list of best guesses.

3. The method of claim 2 further comprising awarding a prize to a guess with the lowest difference.

4. The method of claim 2 wherein the prize is selected from the group consisting of points, credits, money, an item, and a service.

5. The method of claim 1 further comprising storing the list of qualifying guesses in a machine-readable form.

6. The method of claim 1 wherein the list of guesses is obtained after the auction begins and before the auction ends.

7. The method of claim 1 wherein a guess having the highest value is displayed to participants in the auction during the auction.

8. The method of claim 1 wherein the auction is conducted over a network.

9. The method of claim 1 wherein the method is operable in an apparatus comprising a processor and memory.

10. The method of claim 5, wherein the list of qualifying guesses in machine-readable form is selected from the group comprising an XML file, a character-delimited file, and a database.

11. The method of claim 9, wherein the apparatus further comprises a Web server containing a website with a network connection to a client.

12. The method of claim 1, wherein the auction is selected from the group comprising no-reserve open ascending price auctions and reserve open ascending price auctions.

13. A system for an auction closing price guessing game comprising:
a processor;
memory operably connected to the processor;
a client bidding and guessing program loaded into the memory and operable by the processor;
an auction end program loaded into the memory and operable by the processor;
a month end program loaded into the memory and operable by the processor;
a list of user data loaded into the memory and operable by the processor;
a list of item listings loaded into the memory and operable by the processor;
a list of bids data loaded into the memory and operable by the processor;
a list of guesses data loaded into the memory and operable by the processor; and
current time data loaded into said memory and operable by said processor.

14. The system of claim 13, wherein the client bidding and guessing program instructs the processor to provide the list of item listings to a client in communication with the processor; responsive to receiving bid data from the client, record the bid data in machine readable form to the list of bids data; and responsive to receiving guess data from the client, record the guest data in machine readable form to the list of guesses data.

15. The system of claim 13, wherein the auction end program instructs the processor to search the list of items listings for an auction that has just ended; responsive to finding an auction that is just ended, determine if there was a winning bid; responsive to determining there was a winning bid, determine if there are any guesses in the list of guesses data; responsive to determining there is at least one guess in the list of guesses data, determine which guess in the list of guesses data was the first guess; responsive to determining the first guess in the list of guesses data, record points for the first guess in the list of user data; responsive to determining there is at least one guess in the list of guesses data, determine if any of the guesses in the list of guesses data are qualified best guesses; responsive to determining there is at least one qualified best guess in the list of guesses data, record points for each qualified best guess in the list of user data; responsive to determining there is at least one qualified best guess in the list of guesses data, determine if each best guess was made at least a predetermined period of time before the auction ended; responsive to determining there is at least one best guess made at least a predetermined period of time before the auction ended, record a multiplier in the list of user data; responsive to determining there is at least one guess in the list of guesses data, record participation points for each guess in the list of user data; and responsive to determining there is at least one guess in the list of guesses data, calculate and record a total of all points recorded in the list of user data.

16. The system of claim 13, wherein the month end program instructs the processor to determine if the month has ended; responsive to determining the month has ended, sort the list of user data from highest total of all points recorded to the lowest total of all points recorded; record a prize to an entry in the list of user data having the highest total of all points recorded; and record a value of zero for the total of all points recorded for all entries in the list of user data.

17. The system of claim 13, wherein the list of item listings is user-configurable to only allow entries to be provided to the client that have an auction type of no-reserve open ascending price auction or reserve open ascending price auction, condition of used, no buy it now price, and an auction end time that is a user-configurable time after the current time.

18. A computer program product for providing an auction closing price guessing game comprising:
a computer readable medium;
first program instructions to obtain a list of guesses of winning bid prices for an item at auction;
second program instructions to obtain a winning bid price for the item at auction;
third program instructions to determine if each guess in the list of guesses is greater than or equal to the winning bid price;
fourth program instructions to record the guess in a list of qualifying guesses if the guess is greater than or equal to the winning bid price;
fifth program instructions to calculate the difference between each guess in the list of qualifying guesses and the winning bid price;
sixth program instructions to record the difference in the list of qualifying guesses;
seventh program instructions to sort the guesses in the list of qualifying guesses from the lowest difference to the highest difference;
eighth program instructions to record the sorted guesses in a list of best guesses; and
ninth program instructions to award a prize to a guess with the lowest difference.

19. The computer program of claim 18, wherein the list of guesses and the winning bid price are obtained from a website.

20. The computer program of claim 18, wherein the list of guesses is obtained while the item is being auctioned and the winning bid price is obtained after the item has been auctioned.
